(19) United States
(12) Patent Application Publication
(10) Pub. No.: US 2025/0389750 A1
(43) Pub. Date: Dec. 25, 2025

(54) VEHICLE SPEED ESTIMATION DEVICE, POSITION CALCULATION DEVICE, AND STORAGE MEDIUM STORING PROGRAM

(71) Applicant: DENSO CORPORATION, Kariya-city (JP)

(72) Inventors: Noriyoshi SUZUKI, Nagakute-shi (JP); Satoshi MAKIDO, Nagakute-shi (JP); Akira MIYAJIMA, Kariya-city (JP); Shin YOSHIZAWA, Kariya-city (JP)

(21) Appl. No.: 19/317,337

(22) Filed: Sep. 3, 2025

Related U.S. Application Data
(63) Continuation of application No. PCT/JP2024/010881, filed on Mar. 20, 2024.

(30) Foreign Application Priority Data
Mar. 24, 2023 (JP) 2023-049068

(51) Int. Cl. G01P 21/02; G01P 3/481; G01P 7/00; G01S 19/07

(52) U.S. Cl. CPC G01P 21/02; G01P 3/481; G01P 7/00; G01S 19/07

(57) ABSTRACT

A vehicle speed estimation device is configured to calculate a first vehicle speed of a vehicle based on a wheel speed sensor, calculate a second vehicle speed of the vehicle based on a signal from a positioning satellite, estimate a scale factor corresponding to the first vehicle speed, based on a ratio of the second vehicle speed to the first vehicle speed and a relationship with the first vehicle speed, and estimate an actual vehicle speed of the vehicle by multiplying the first vehicle speed by the scale factor.

### CROSS REFERENCE TO RELATED APPLICATION

The present application is a continuation application of International Patent Application No. PCT/JP2024/010881 filed on Mar. 20, 2024 which designated the U. S. and claims the benefit of priority from Japanese Patent Application No. 2023-049068 filed on Mar. 24, 2023. The entire disclosures of all of the above applications are incorporated herein by reference.

### TECHNICAL FIELD

The present disclosure relates to a vehicle speed estimation device and a program.

### BACKGROUND

A related art discloses a technique in which a speed error is estimated based on the correlation between the difference between the vehicle speed calculated by wheel speed and the vehicle speed calculated by GPS, and the acceleration of the vehicle, and the vehicle speed calculated by wheel speed is corrected based on the speed error.

### SUMMARY

According to an aspect of the present disclosure, a vehicle speed estimation device includes at least one processor configured to cause the vehicle speed estimation device to: calculate a first vehicle speed of a vehicle based on a wheel speed sensor; calculate a second vehicle speed of the vehicle based on a signal from a positioning satellite; estimate a scale factor corresponding to the first vehicle speed, based on a ratio of the second vehicle speed to the first vehicle speed and a relationship with the first vehicle speed; estimate an actual vehicle speed of the vehicle by multiplying the first vehicle speed by the scale factor; calculate acceleration of the vehicle by an acceleration sensor; and calculate a speed variation amount, which is a change in speed obtained by integrating the acceleration. The at least one processor may be further configured to: estimate the scale factor corresponding to the first vehicle speed, based on the ratio of the second vehicle speed to the first vehicle speed and the relationship with the first vehicle speed, when the acceleration is equal to or less than a threshold value; and estimate the actual vehicle speed based on the scale factor corresponding to the first vehicle speed when the acceleration is equal to or less than the threshold value, and estimates the actual vehicle speed by adding the speed variation amount based on the acceleration to the first vehicle speed when the acceleration exceeds the threshold value.

### BRIEF DESCRIPTION OF DRAWINGS

Objects, features and advantages of the present disclosure will become more apparent from the following detailed description made with reference to the accompanying drawings. In the drawings:

FIG. 1 is a block diagram illustrating an example of the configuration of a vehicle speed estimation system according to the first embodiment;

FIG. 2 is a schematic block diagram of a vehicle speed estimation device according to the first embodiment;

FIG. 3 is an explanatory diagram showing the relationship between the actual vehicle speed and the scale factor with respect to the wheel speed according to the first embodiment;

FIG. 4 is an explanatory diagram for explaining an example of the operational flow of the vehicle speed estimation device according to the first embodiment;

FIG. 5 is an explanatory diagram for explaining an example of the operational flow of the vehicle speed estimation device according to the second embodiment;

FIG. 6 is a block diagram illustrating an example of the configuration of a vehicle speed estimation system according to the third embodiment;

FIG. 7 is an explanatory diagram for explaining an example of the operational flow of the vehicle speed estimation device according to the third embodiment;

FIG. 8 is a block diagram illustrating an example of the configuration of a vehicle speed estimation system according to the fourth embodiment;

FIG. 9 is a block diagram illustrating an example of the configuration of a vehicle speed estimation system according to the fifth embodiment;

FIG. 10 is a block diagram illustrating an example of the configuration of a vehicle speed estimation system according to the sixth embodiment;

FIG. 11A is an explanatory diagram for explaining the time lag according to the sixth embodiment; and

FIG. 11B is an explanatory diagram for explaining the time lag according to the sixth embodiment.

### DETAILED DESCRIPTION

It is known that errors arising in vehicle speed differ depending on the speed of the vehicle. In the technique described in the related art, it is not possible to correct errors according to the vehicle speed, resulting in low accuracy of the estimated speed.

The present disclosure provides a vehicle speed estimation device, a position calculation device, and a program capable of calculating an actual vehicle speed with high accuracy by correcting the vehicle speed calculated using a wheel speed sensor.

According to a first aspect of the present disclosure, a vehicle speed estimation device comprises: a first vehicle speed calculation unit configured to calculate a first vehicle speed of a vehicle using a wheel speed sensor; a second vehicle speed calculation unit configured to calculate a second vehicle speed of the vehicle based on a signal from a positioning satellite; a scale factor estimation unit configured to estimate a scale factor corresponding to the first vehicle speed, based on the ratio between the first vehicle speed and the second vehicle speed and the relationship with the first vehicle speed; and a vehicle speed estimation unit configured to estimate an actual vehicle speed of the vehicle by multiplying the first vehicle speed by the scale factor.

According to the vehicle speed estimation device of the first aspect, it is possible to provide a vehicle speed estimation device capable of calculating an actual vehicle speed with high accuracy by correcting the vehicle speed calculated using a wheel speed sensor.

According to a second aspect of the present disclosure, in the vehicle speed estimation device, the scale factor estimation unit divides a speed range of the vehicle into a plurality of segments and estimates the scale factor for each speed range.

According to the vehicle speed estimation device of the second aspect, it is possible to provide a vehicle speed estimation device in which the processing for estimating the scale factor can be simplified compared to the case where the scale factor is estimated for each first vehicle speed.

According to a third aspect of the present disclosure, the vehicle speed estimation device further comprises an acceleration calculation unit configured to calculate acceleration from the first vehicle speed, and the scale factor estimation unit estimates the scale factor corresponding to the first vehicle speed based on the ratio between the first vehicle speed and the second vehicle speed and the relationship among the first vehicle speed and the acceleration.

According to the vehicle speed estimation device of the third aspect, it is possible to provide a vehicle speed estimation device capable of calculating the actual vehicle speed with higher accuracy compared to the case where the error of the first vehicle speed is not corrected using the acceleration of the vehicle.

According to a fourth aspect of the present disclosure, the vehicle speed estimation device further comprises an acceleration calculation unit configured to calculate acceleration of the vehicle by an acceleration sensor, and the scale factor estimation unit estimates a scale factor corresponding to the first vehicle speed and the acceleration, based on the ratio between the first vehicle speed and the second vehicle speed and the relationship among the first vehicle speed and the acceleration.

According to the vehicle speed estimation device of the fourth aspect, it is possible to provide a vehicle speed estimation device capable of calculating the actual vehicle speed with higher accuracy compared to the case where the error of the first vehicle speed is not corrected using the acceleration of the vehicle.

According to a fifth aspect of the present disclosure, the vehicle speed estimation device further comprises an acceleration calculation unit configured to calculate acceleration of the vehicle by an acceleration sensor, and a speed variation calculation unit configured to calculate a speed variation amount, which is a change in speed obtained by integrating the acceleration. The scale factor estimation unit estimates the scale factor corresponding to the first vehicle speed, based on the ratio between the first vehicle speed and the second vehicle speed and the relationship with the first vehicle speed, when the acceleration is equal to or less than a threshold value. The vehicle speed estimation unit estimates the actual vehicle speed based on the scale factor corresponding to the first vehicle speed when the acceleration is equal to or less than the threshold value, and estimates the actual vehicle speed by adding the speed variation amount based on the acceleration to the first vehicle speed when the acceleration exceeds the threshold value.

According to the vehicle speed estimation device of the fifth aspect, it is possible to provide a vehicle speed estimation device capable of calculating the actual vehicle speed with higher accuracy even when the acceleration is large.

According to a sixth aspect of the present disclosure, the vehicle speed estimation device further comprises an acceleration calculation unit configured to calculate acceleration of the vehicle by an acceleration sensor, and a time lag calculation unit configured to calculate a time lag amount between the first vehicle speed and the second vehicle speed, based on the difference between the first vehicle speed corrected by the scale factor estimated by the scale factor estimation unit according to the first vehicle speed and the second vehicle speed, with respect to the acceleration. The scale factor estimation unit estimates the scale factor corresponding to the first vehicle speed, based on the ratio between the first vehicle speed and the second vehicle speed and the relationship with the first vehicle speed, when the acceleration is equal to or less than a threshold value. The vehicle speed estimation unit estimates the actual vehicle speed based on the scale factor corresponding to the first vehicle speed when the acceleration is equal to or less than the threshold value, and outputs the actual vehicle speed by shifting the reference time for the first vehicle speed by the time lag amount corresponding to the time lag when the acceleration exceeds the threshold value.

According to the vehicle speed estimation device of the sixth aspect, it is possible to calculate the actual vehicle speed with higher accuracy regardless of the magnitude of the acceleration.

According to a seventh aspect of the present disclosure, a position calculation device comprises a vehicle speed estimation device configured to estimate an actual vehicle speed of a vehicle, and a position calculation device configured to calculate a position of the vehicle based on the actual vehicle speed estimated by the vehicle speed estimation device. The vehicle speed estimation device comprises: a first vehicle speed calculation unit configured to calculate a first vehicle speed of the vehicle based on a wheel speed sensor; a second vehicle speed calculation unit configured to calculate a second vehicle speed of the vehicle based on signals from a positioning satellite; a scale factor estimation unit configured to estimate a scale factor corresponding to the first vehicle speed, based on the ratio between the first vehicle speed and the second vehicle speed and the relationship with the first vehicle speed; and a vehicle speed estimation unit configured to estimate the actual vehicle speed of the vehicle by multiplying the first vehicle speed by the scale factor.

According to the position calculation device of the seventh aspect, it is possible to provide a position calculation device capable of calculating the position of the vehicle with high accuracy based on a highly accurate vehicle speed.

According to an eighth aspect of the present disclosure, a program causes a computer to function as: a first vehicle speed calculation unit configured to calculate a first vehicle speed of a vehicle based on a wheel speed sensor; a second vehicle speed calculation unit configured to calculate a second vehicle speed of the vehicle based on a signal from a positioning satellite; a scale factor estimation unit configured to estimate a scale factor corresponding to the first vehicle speed, based on the ratio between the first vehicle speed and the second vehicle speed and the relationship with the first vehicle speed; and a vehicle speed estimation unit configured to estimate an actual vehicle speed of the vehicle by multiplying the first vehicle speed by the scale factor.

According to the program of the eighth aspect, it is possible to provide a program capable of calculating an actual vehicle speed with high accuracy by correcting the vehicle speed calculated using a wheel speed sensor.

Hereinafter, an example of the present embodiment will be described in detail with reference to the drawings.

### First Embodiment

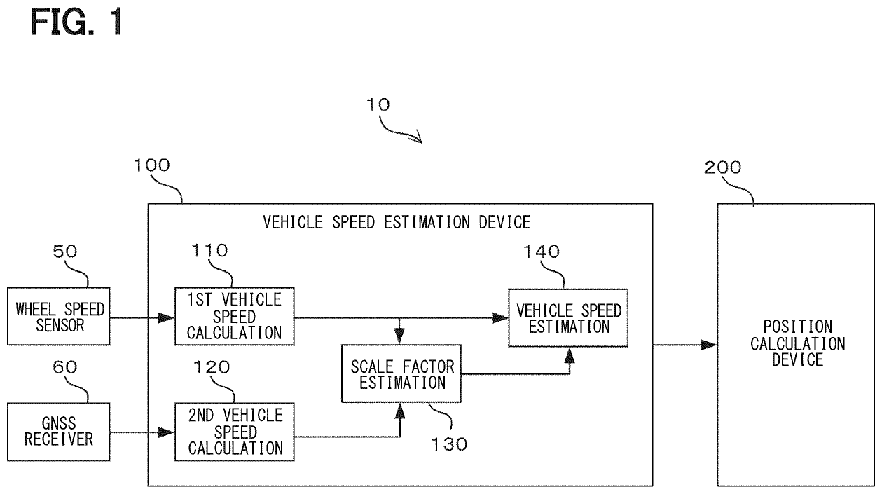

FIG. 1 is a block diagram illustrating an example of the system configuration of a vehicle speed estimation system 10 according to the first embodiment. As shown in FIG. 1, the vehicle speed estimation system 10 according to the present embodiment includes a wheel speed sensor 50, a GNSS (Global Navigation Satellite System) receiver 60, a vehicle speed estimation device 100, and a position calculation device 200.

The wheel speed sensor 50 is mounted on a vehicle and detects the number of pulses generated by the rotation of the tire per unit time. The detected number of pulses is provided to the first vehicle speed calculation unit 110.

The GNSS receiver 60 receives signals from positioning satellites. The received signals are provided to the second vehicle speed calculation unit 120.

The vehicle speed estimation device 100 is a device that estimates the speed of the vehicle. The vehicle speed estimation device 100 is mounted on the vehicle whose speed is to be estimated. The vehicle speed estimation device 100 is not limited to the case where all components are mounted on the vehicle whose speed is to be estimated, and a part of the configuration of the vehicle speed estimation device 100 may be provided in another device connected to the vehicle via a network (not shown).

The position calculation device 200 is a device that calculates the position of the vehicle based on the vehicle speed estimated by the vehicle speed estimation device 100. The position calculation device 200 is also mounted on the vehicle whose position is to be calculated. The position calculation device 200 is not limited to being mounted on the vehicle, and a part of the configuration may be provided in another device connected to the vehicle via a network (not shown). Further, the position calculation device 200 is not limited to being provided as a device separate from the vehicle speed estimation device 100, and its functions may be included in the vehicle speed estimation device 100.

The vehicle speed estimation device 100 and the position calculation device 200 as shown in FIG. 1 can be configured by a computer including a CPU, a RAM, and a ROM storing programs for executing various processing routines and various data, as will be described later. Since the vehicle speed estimation device 100 and the position calculation device 200 are basically general computer configurations, the vehicle speed estimation device 100 will be described as a representative example.

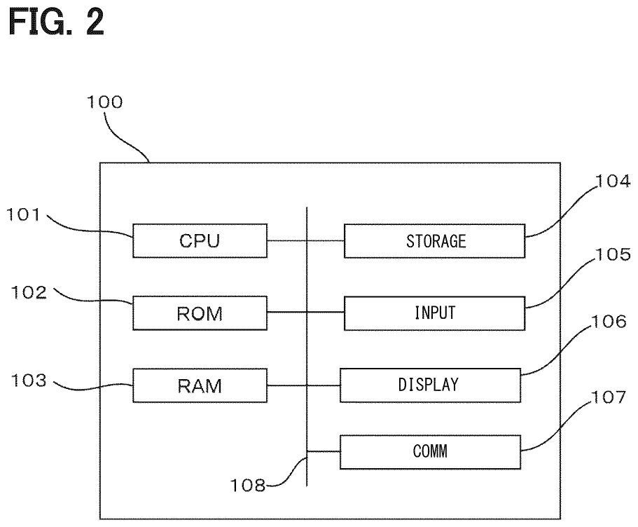

FIG. 2 is a block diagram showing the hardware configuration of the vehicle speed estimation device 100.

As shown in FIG. 2, the vehicle speed estimation device 100 includes a CPU (Central Processing Unit) 101, a ROM (Read Only Memory) 102, a RAM (Random Access Memory) 103, a storage 104, an input device 105, a display device 106, and a communication unit 107. Each component is communicably connected to each other via a bus 108.

The CPU 101 is a central processing unit that executes various programs and controls each unit. That is, the CPU 101 reads a program from the ROM 102 or the storage 104 and executes the program using the RAM 103 as a work area. The CPU 101 performs control of each component and various arithmetic processing according to programs recorded in the ROM 102 or the storage 104. In the present embodiment, programs are stored in the ROM 102 or the storage 104.

The ROM 102 stores various programs and various data. The RAM 103 temporarily stores programs or data as a work area. The storage 104 is constituted by an HDD (Hard Disk Drive) or an SSD (Solid State Drive), and stores various programs including an operating system and various data.

The input device 105 includes a pointing device such as a mouse and a keyboard, and is used for various inputs.

The display device 106 is, for example, a liquid crystal display. The display device 106 displays various information under the control of the CPU 101.

The display device 106 may also adopt a touch panel system and function as the input device 105.

The communication unit 107 is for communicating with the wheel speed sensor 50, the GNSS receiver 60, the position calculation device 200, and the like.

The vehicle speed estimation device 100 realizes various functions using the above hardware resources. The functional configuration realized by the vehicle speed estimation device 100 will be described with reference to FIG. 1. Functionally, as shown in FIG. 1, the vehicle speed estimation device 100 includes a first vehicle speed calculation unit 110, a second vehicle speed calculation unit 120, a scale factor estimation unit 130, and a vehicle speed estimation unit 140.

The first vehicle speed calculation unit 110 calculates a first vehicle speed of the vehicle from the number of pulses detected by the wheel speed sensor 50 and the circumference of the tire. Hereinafter, the first vehicle speed is also referred to as “wheel speed.” The calculated wheel speed is provided to the scale factor estimation unit 130 and the vehicle speed estimation unit 140.

The second vehicle speed calculation unit 120 calculates a second vehicle speed of the vehicle based on signals from positioning satellites received by the GNSS receiver 60. Hereinafter, the second vehicle speed is also referred to as “GNSS speed.” The calculated GNSS speed is provided to the scale factor estimation unit 130. Here, the GNSS speed calculated based on signals from positioning satellites is more accurate than the wheel speed. That is, although the GNSS speed calculated based on signals from positioning satellites is susceptible to the visibility of the satellites from the vehicle and the surrounding environment such as buildings, it is known that the vehicle speed obtained from Doppler information has a small offset component and high accuracy.

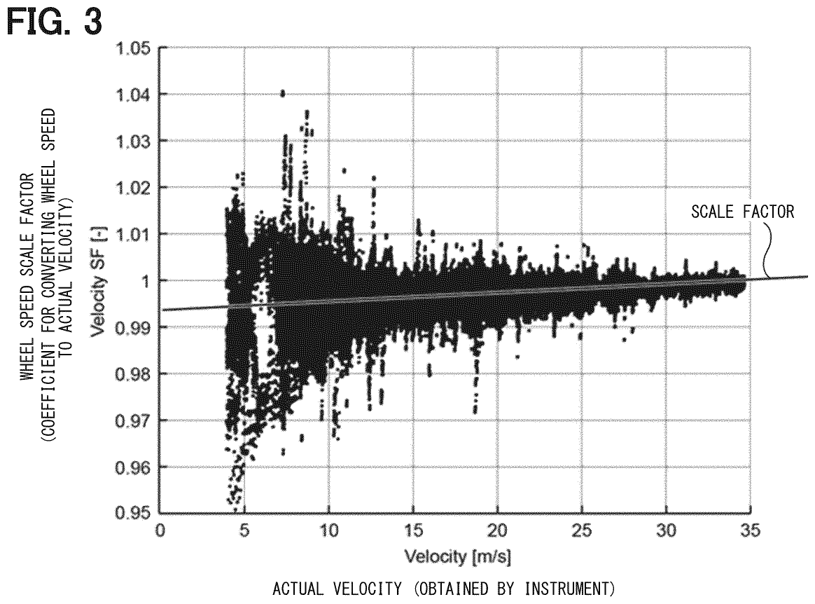

The scale factor estimation unit 130 estimates a scale factor corresponding to the wheel speed based on the ratio of the GNSS speed to the wheel speed (GNSS speed/wheel speed: numerator is GNSS speed, denominator is wheel speed) and the relationship with the wheel speed. Specifically, the scale factor is estimated by calculating the ratio of the GNSS speed to the wheel speed, and correcting the calculated ratio based on the relationship with the wheel speed as shown in FIG. 3. Here, FIG. 3 is an explanatory diagram showing the relationship between the actual vehicle speed and the scale factor with respect to the wheel speed. The actual velocity in FIG. 3 is the correct value of the vehicle speed measured by an instrument. In FIG. 3, the points represent the wheel speed, and the straight line represents the estimated scale factor. From FIG. 3, it can be seen that as the actual velocity increases, the scale factor applied to the wheel speed also increases. That is, as the wheel speed increases, the difference from the actual vehicle speed becomes larger, and thus the scale factor also needs to be increased. Here, the estimation of the scale factor may be performed based on the relationship between the wheel speed and the actual vehicle speed calculated using the least squares method, but is not limited thereto. Based on the straight line shown in FIG. 3, a function of the scale factor is created as a linear equation using the slope and the intercept. The scale factor is then estimated by inputting the wheel speed into this function. The scale factor may also be estimated by first correcting the wheel speed according to the change in the tire radius corresponding to the speed, and then calculating the ratio of the GNSS speed to the wheel speed. Furthermore, the function of the scale factor is not limited to a linear equation.

The cause of error will be explained here. The tire radius varies depending on the type of tire, air pressure, and wear rate, so the scale factor is estimated based on the condition of the tires mounted on the vehicle to calculate the actual velocity. However, it is known that the tire radius changes with the speed of the vehicle during driving, due to factors such as changes in centrifugal force and temperature (including air pressure). Therefore, the error between the wheel speed and the actual vehicle speed increases as the vehicle speed increases. That is, for example, if a scale factor assumed for a low-speed range is continuously used in a high-speed range, a position error will continuously occur in the rearward direction of the vehicle, resulting in an increase in the position error. Accordingly, by estimating the scale factor according to the speed of the vehicle during driving, it is possible to improve the accuracy of calculating the actual velocity.

The vehicle speed estimation unit 140 estimates the actual vehicle speed of the vehicle by multiplying the wheel speed by the scale factor.

A specific example of calculating the actual vehicle speed of the vehicle will be described. For example, if the wheel speed is 25 m/s and the GNSS speed is 26 m/s, the ratio of the GNSS speed to the wheel speed is 1.04. If, from the function of the scale factor, the wheel speed scale factor at 25 m/s is, for example, 0.998, then correcting the ratio of the GNSS speed to the wheel speed by the wheel speed scale factor yields 1.04×0.998=1.03792. This value is the scale factor estimated by the scale factor estimation unit 130. Multiplying the scale factor by the wheel speed of 25 m/s yields 25 m/s×1.03792=25.948. This value is the actual vehicle speed estimated by the vehicle speed estimation unit 140.

The position calculation device 200 calculates the position of the vehicle based on the actual vehicle speed calculated by the vehicle speed estimation device 100. That is, in dead reckoning navigation, which calculates the vehicle speed using the wheel speed, the position of the vehicle in the direction of travel is calculated based on how far the vehicle has traveled according to the wheel speed.

Next, the operation of the vehicle speed estimation device 100 will be explained.

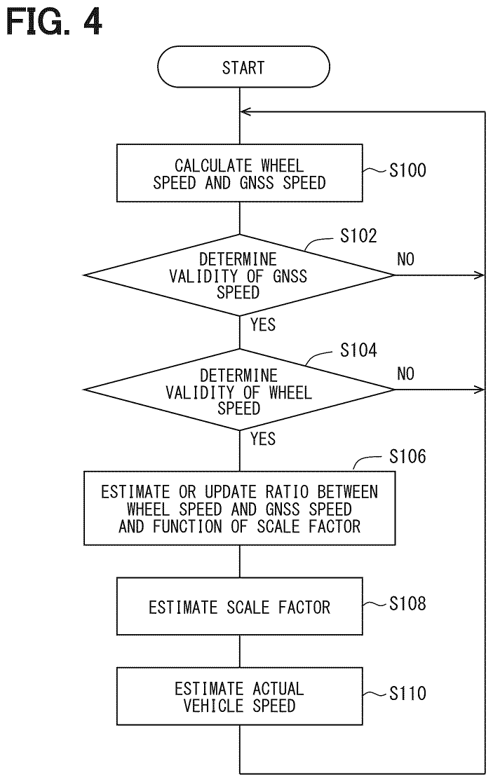

FIG. 4 is a diagram illustrating an example of the operational flow of the CPU 101 in the vehicle speed estimation device 100 according to the first embodiment.

First, in step S100, the first vehicle speed calculation unit 110 calculates the wheel speed of the vehicle from the number of pulses received from the wheel speed sensor 50 and the circumference of the tire, and the second vehicle speed calculation unit 120 calculates the GNSS speed of the vehicle based on the signals from the positioning satellite received by the GNSS receiver 60. Then, the process proceeds to the next step S102.

In step S102, the second vehicle speed calculation unit 120 determines the validity of the GNSS speed. For example, the accuracy of the GNSS speed is determined based on factors such as DOP (Dilution Of Precision) or residuals. If it is determined that the GNSS speed is valid, the process proceeds to the next step S104. On the other hand, if it is determined that the GNSS speed is not valid, the process returns to the above-described step S100.

In step S104, the first vehicle speed calculation unit 110 determines the validity of the wheel speed. For example, it is determined whether the acceleration is equal to or less than a threshold value, and/or whether the wheel speed is equal to or greater than a threshold value. If the acceleration exceeds the threshold value or the wheel speed is less than the threshold value, it is determined that the wheel speed is not valid. If it is determined that the wheel speed is valid, the process proceeds to the next step S106. On the other hand, if it is determined that the wheel speed is not valid, the process returns to the above-described step S100.

In step S106, the ratio between the wheel speed and the GNSS speed, and the above-described function of the scale factor, are estimated or updated. Then, the process proceeds to the next step S108.

In step S108, the scale factor is estimated from the wheel speed using the function of the scale factor. Then, the process proceeds to the next step S110.

In step S110, the actual vehicle speed of the vehicle is estimated by multiplying the wheel speed by the scale factor. This processing is repeated continuously.

This processing may be repeated continuously at all times, or may be started on various triggers.

As described above, according to the present embodiment, it is possible to calculate the actual vehicle speed with high accuracy by correcting the vehicle speed calculated using the wheel speed sensor 50. That is, it is possible to calculate a highly accurate actual vehicle speed by taking into account changes in the tire radius that vary with the speed of the vehicle. Furthermore, it is possible to calculate the position of the vehicle based on the highly accurate actual vehicle speed thus calculated.

### Second Embodiment

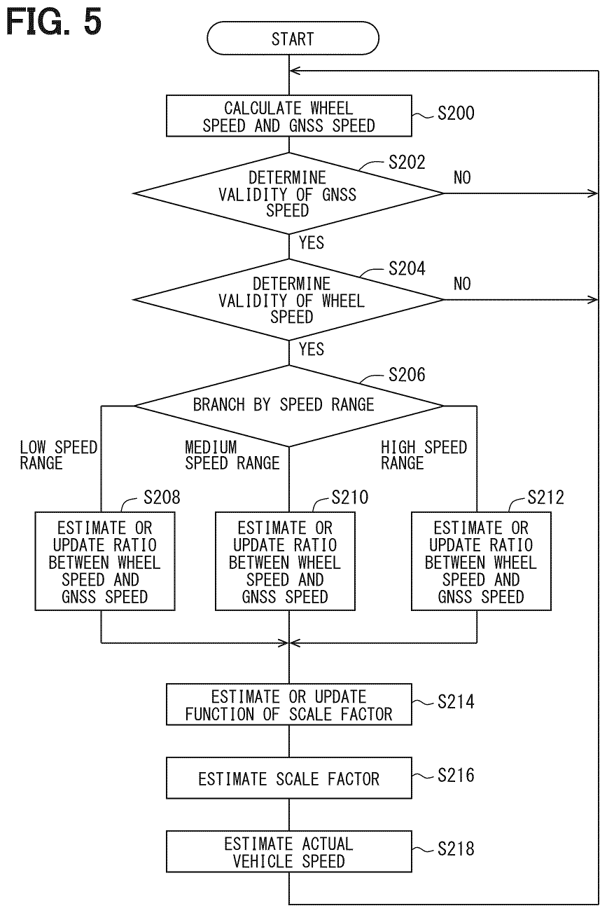

Next, the second embodiment will be described with reference to FIG. 5. In the first embodiment described above, the scale factor estimation unit 130 estimates the scale factor for each wheel speed. In the second embodiment, the scale factor estimation unit 130 differs in that it estimates the scale factor for each speed range. The following explanation will focus on the parts that differ from the first embodiment described above, and overlapping portions will be simplified or omitted.

The scale factor estimation unit 130 estimates the scale factor in each of a plurality of divided speed ranges. For example, although not shown, the speed range may be divided into three: a low-speed range of 0 m/s or more and less than 10 m/s, a medium-speed range of 10 m/s or more and less than 20 m/s, and a high-speed range of 20 m/s or more. The scale factor estimation unit 130 estimates the scale factor at one speed in each speed range. Here, the one speed may include, for example, the center point of each speed range. The scale factors for each speed range are connected by an approximate straight line, and a function of the scale factor is created based on this approximate straight line. This enables the scale factor to be estimated from various wheel speeds. The speed ranges are not limited to being divided into three; they may be divided into two or more ranges.

Next, the operation of the vehicle speed estimation device 100 will be described.

FIG. 5 is an explanatory diagram showing an example of the operational flow of the CPU 101 of the vehicle speed estimation device 100 according to the second embodiment.

First, in step S200, the first vehicle speed calculation unit 110 calculates the wheel speed of the vehicle from the number of pulses received from the wheel speed sensor 50 and the circumference of the tire, and the second vehicle speed calculation unit 120 calculates the GNSS speed of the vehicle based on the signals from the positioning satellite received by the GNSS receiver 60. Then, the process proceeds to the next step S202.

In step S202, the second vehicle speed calculation unit 120 determines the validity of the GNSS speed. For example, the accuracy of the GNSS speed is determined based on DOP (Dilution Of Precision) or residuals. If it is determined that the GNSS speed is valid, the process proceeds to the next step S204. On the other hand, if it is determined that the GNSS speed is not valid, the process returns to the above-described step S200.

In step S204, the first vehicle speed calculation unit 110 determines the validity of the wheel speed. For example, it is determined whether the acceleration is equal to or less than a threshold value, and/or whether the wheel speed is equal to or greater than a threshold value. If the acceleration exceeds the threshold value or the wheel speed is less than the threshold value, it is determined that the wheel speed is not valid. If it is determined that the wheel speed is valid, the process proceeds to the next step S206. On the other hand, if it is determined that the wheel speed is not valid, the process returns to the above-described step S200.

In step S206, for each wheel speed calculated in step S200 described above, the process branches into the low-speed range, medium-speed range, or high-speed range. The process then proceeds to step S208, step S210, or step S212, respectively.

In steps S208, S210, and S212, the ratio of the GNSS speed to the wheel speed is estimated or updated. Then, the process proceeds to the next step S214.

In step S214, the scale factor function is estimated or updated. Then, the process proceeds to the next step S216.

In step S216, the scale factor is estimated from the wheel speed using the function of the scale factor. Then, the process proceeds to the next step S218.

In step S218, the actual vehicle speed of the vehicle is estimated by multiplying the wheel speed by the scale factor. This processing is repeated.

In the present embodiment, by configuring the system in this way, it is possible to simplify the processing for estimating the scale factor compared to the case where the scale factor is estimated for each wheel speed.

### Third Embodiment

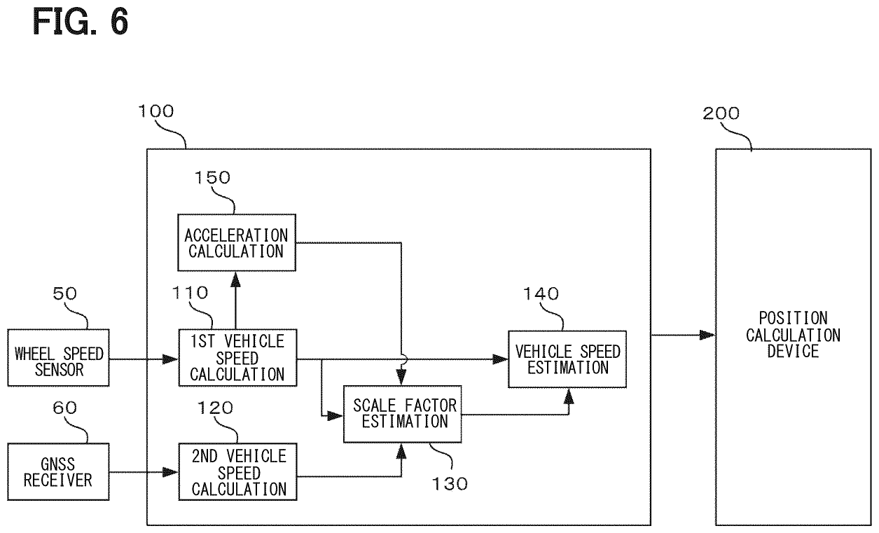

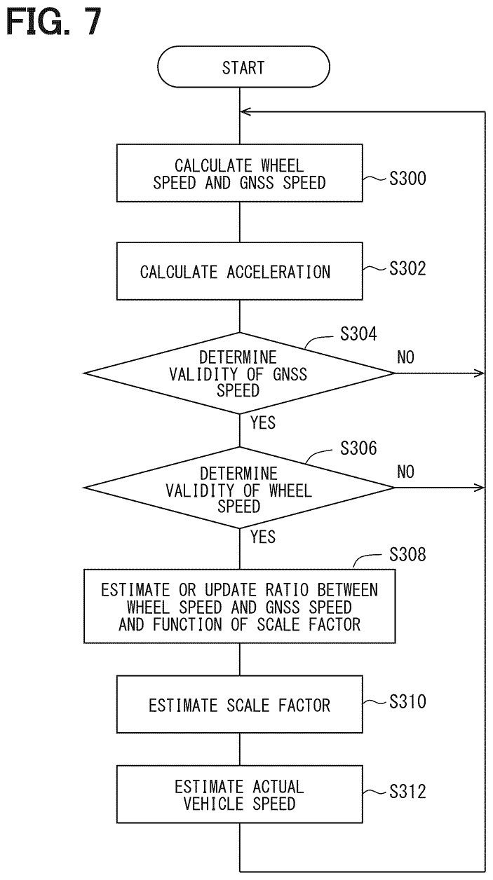

Next, the third embodiment will be described with reference to FIG. 6 and FIG. 7.

In the first embodiment described above, the scale factor estimation unit 130 does not take into account the acceleration (longitudinal acceleration) of the vehicle in estimating the scale factor. In contrast, in the third embodiment, the scale factor estimation unit 130 estimates the scale factor by taking acceleration into consideration. The following explanation will focus on the parts that differ from the first embodiment described above, and overlapping portions will be simplified or omitted.

Functionally, as shown in FIG. 6, the vehicle speed estimation device 100 includes an acceleration calculation unit 150.

The acceleration calculation unit 150 calculates acceleration (longitudinal acceleration) from the wheel speed. The calculation of acceleration is performed using known techniques. For example, acceleration may be calculated by estimating the slope of the speed change from the time difference or time series data of the wheel speed.

The scale factor estimation unit 130 estimates a scale factor corresponding to the wheel speed, based on the ratio of the GNSS speed to the wheel speed, and the relationship among the wheel speed and the acceleration. Here, the error in the wheel speed is negatively correlated with acceleration, and is proportional to the magnitude of the acceleration. That is, as the acceleration increases, the error increases. In addition, the error changes in proportion to the wheel speed. Therefore, the scale factor estimation unit 130 estimates the error in the wheel speed using the following equations, and estimates the scale factor using the wheel speed after correcting for the error caused by acceleration.

$$\frac{V 1 - V 2}{V 1} = ax \qquad ( Equation 1 )$$

$$e = {a}_{e} x V 1 \qquad ( Equation 2 )$$

Here, V1 is the pre-correction vehicle speed pulse value, x is the acceleration of the vehicle, and α is a coefficient. Further, e is the estimated value of the wheel speed error, and αₑ is the estimated value of the coefficient α. The estimated value αₑ may be estimated, for example, by applying the least squares method to Equation (1). By using the least squares method, the processing time required to obtain the estimated value de can be shortened. The corrected wheel speed is calculated by subtracting the estimated value of the error from the wheel speed.

The cause of errors dependent on acceleration will be explained here. It is known that the tire radius varies due to changes in tire load or slip ratio during vehicle acceleration or deceleration. Therefore, the difference between the wheel speed and the actual vehicle speed arises due to acceleration. Even if the tire radius does not change, if there is a time lag between the wheel speed and the actual vehicle speed, the timing of speed changes will differ, resulting in an apparent speed error proportional to the acceleration. Therefore, using a scale factor estimated with consideration of acceleration enables higher accuracy in calculating the actual vehicle speed than using a scale factor estimated without considering acceleration. In the case of error estimation, the GNSS speed referred to is regarded as the actual vehicle speed.

Next, the operation of the vehicle speed estimation device 100 will be described.

FIG. 7 is an explanatory diagram showing an example of the operational flow of the vehicle speed estimation device 100 according to the third embodiment.

First, in step S300, the first vehicle speed calculation unit 110 calculates the wheel speed of the vehicle from the number of pulses received from the wheel speed sensor 50 and the circumference of the tire, and the second vehicle speed calculation unit 120 calculates the GNSS speed of the vehicle based on the signals from the positioning satellite received by the GNSS receiver 60. Then, the process proceeds to the next step S302.

In step S302, the acceleration calculation unit 150 calculates acceleration from the wheel speed. Then, the process proceeds to the next step S304.

In step S304, the second vehicle speed calculation unit 120 determines the validity of the GNSS speed. For example, the accuracy of the GNSS speed is determined based on DOP (Dilution Of Precision) or residuals. If it is determined that the GNSS speed is valid, the process proceeds to the next step S306. On the other hand, if it is determined that the GNSS speed is not valid, the process returns to the above-described step S300.

In step S306, the first vehicle speed calculation unit 110 determines the validity of the wheel speed. For example, it is determined whether the acceleration is equal to or less than a threshold value, and/or whether the wheel speed is equal to or greater than a threshold value. If the acceleration exceeds the threshold value or the wheel speed is less than the threshold value, it is determined that the wheel speed is not valid. If it is determined that the wheel speed is valid, the process proceeds to the next step S308. On the other hand, if it is determined that the wheel speed is not valid, the process returns to the above-described step S300.

In step S308, the ratio of the GNSS speed to the wheel speed, and the above-described function of the scale factor, are estimated or updated. Then, the process proceeds to the next step S310.

In step S310, the scale factor is estimated by applying the scale factor function to the wheel speed. Then, the process proceeds to the next step S312.

In step S312, the actual vehicle speed of the vehicle is estimated by multiplying the wheel speed by the scale factor. This processing is repeated.

In the present embodiment, by configuring the system in this way, it is possible to calculate the actual vehicle speed with higher accuracy. That is, it is known that errors occur in the wheel speed calculated from the number of pulses from the wheel speed sensor 50 when the vehicle accelerates or decelerates. By estimating the scale factor after correcting for the error, it is possible to calculate the actual vehicle speed with higher accuracy compared to the case where the error is not corrected.

### Fourth Embodiment

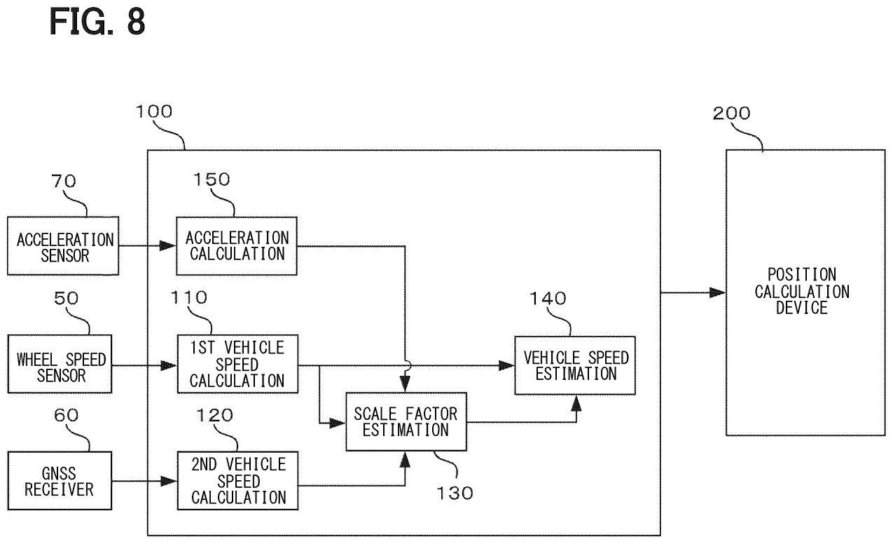

Next, the fourth embodiment will be described with reference to FIG. 8. In the third embodiment described above, the acceleration calculation unit 150 estimated the acceleration; however, in the fourth embodiment, the difference is that the acceleration is calculated using an acceleration sensor. The following explanation will focus on the parts that differ from the first embodiment described above, and overlapping portions will be simplified or omitted.

The vehicle speed estimation system 10 further includes an acceleration sensor 70.

The acceleration sensor 70 is mounted on the vehicle and detects the acceleration (longitudinal acceleration) of the vehicle. The detected acceleration is provided to the acceleration calculation unit 150.

The acceleration calculation unit 150 acquires the acceleration (longitudinal acceleration) detected by the acceleration sensor 70.

In the scale factor estimation unit 130, as in the third embodiment described above, the scale factor corresponding to the wheel speed is estimated based on the ratio of the GNSS speed to the wheel speed, and the relationship among the wheel speed and the acceleration.

### Fifth Embodiment

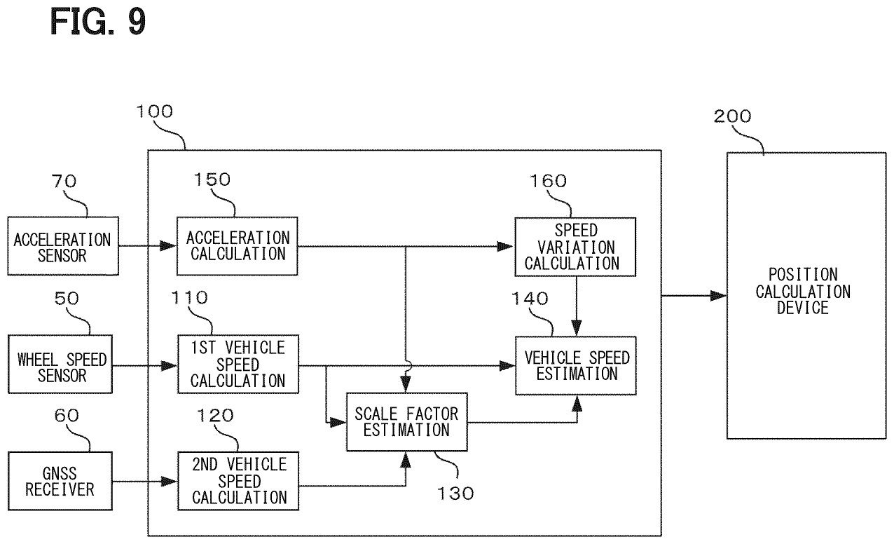

Next, the fifth embodiment will be described with reference to FIG. 9. In the third and fourth embodiments described above, the scale factor is estimated by taking acceleration into consideration. In the fifth embodiment, when the acceleration is equal to or less than a threshold value, the scale factor is estimated and the actual vehicle speed is estimated as in the first embodiment, but when the acceleration exceeds the threshold value, the actual vehicle speed is estimated from the speed variation amount due to acceleration without using the scale factor, which is a point of difference. The following explanation will focus on the parts that differ from the above embodiments, and overlapping portions will be simplified or omitted.

Functionally, as shown in FIG. 9, the vehicle speed estimation device 100 includes a speed variation calculation unit 160.

The speed variation calculation unit 160 calculates a speed variation amount, which is the change in speed obtained by integrating the acceleration.

The scale factor estimation unit 130, when the acceleration calculated by the acceleration calculation unit 150 is equal to or less than the threshold value, estimates the scale factor corresponding to the wheel speed based on the ratio of the GNSS speed to the wheel speed and the relationship with the wheel speed, as in the first embodiment described above. That is, when the acceleration is small, the scale factor is estimated without considering the acceleration, and when the acceleration is large, the scale factor is not estimated. Here, it is desirable that the threshold value of the acceleration be a value small enough to be regarded as substantially constant-speed driving.

The vehicle speed estimation unit 140 estimates the actual vehicle speed based on the scale factor corresponding to the wheel speed estimated by the scale factor estimation unit 130 when the acceleration is equal to or less than the threshold value. That is, in the case of acceleration small enough to be negligible, the actual vehicle speed is estimated using the scale factor as in the first embodiment.

Further, the vehicle speed estimation unit 140 estimates the actual vehicle speed by adding the speed variation amount based on the acceleration to the wheel speed when the acceleration exceeds the threshold value. That is, the actual vehicle speed estimated based on the scale factor when the acceleration exceeds the threshold value is used as the initial value, and the vehicle speed is estimated by adding the speed variation amount.

In the present embodiment, by configuring the system in this way, it is possible to calculate the actual vehicle speed with higher accuracy even when the acceleration is large.

### Sixth Embodiment

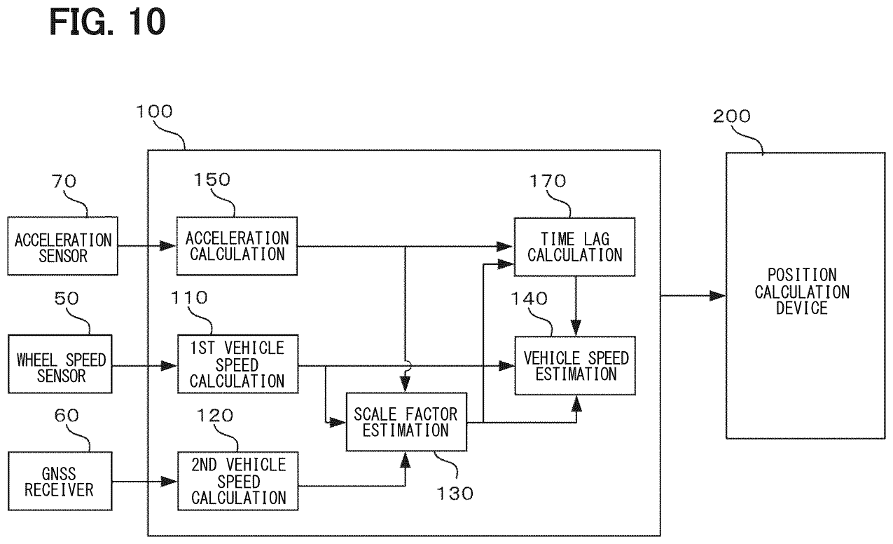

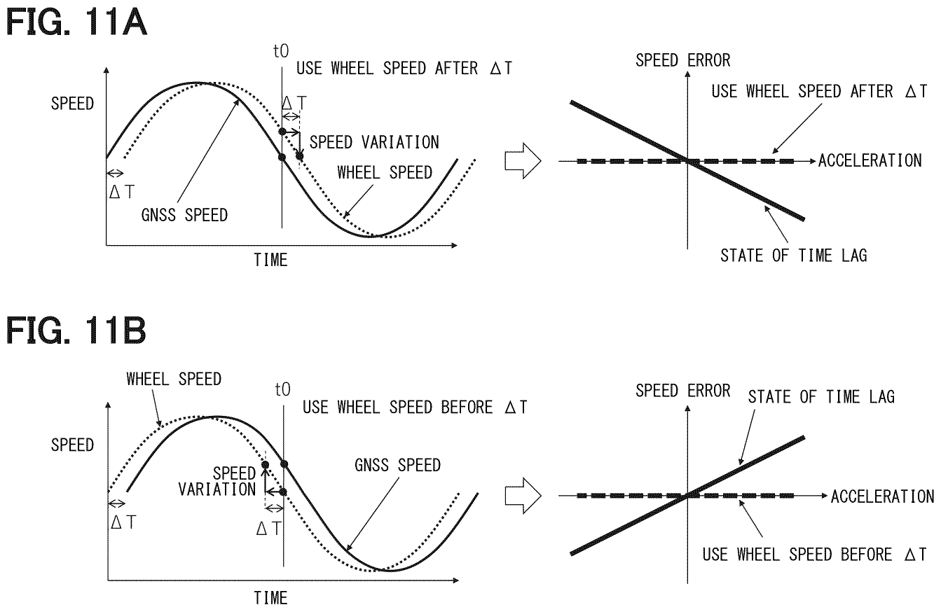

Next, the sixth embodiment will be described with reference to FIG. 10 and FIG. 11A and FIG. 11B. In the sixth embodiment, when the acceleration is equal to or less than a threshold value, the scale factor is estimated by taking the speed into account, and the actual vehicle speed is estimated as in the first embodiment. When the acceleration exceeds the threshold value, the magnitude of the time lag between the wheel speed and the GNSS speed is estimated, and the time at which the wheel speed is referenced is corrected, which is a point of difference. The following explanation will focus on the parts that differ from the above embodiments, and overlapping portions will be simplified or omitted.

Functionally, as shown in FIG. 10, the vehicle speed estimation device 100 includes a time lag calculation unit 170.

The time lag calculation unit 170 calculates the time lag amount between the wheel speed and the GNSS speed, based on the difference between the wheel speed corrected by the scale factor corresponding to the speed and the GNSS speed, with respect to the acceleration.

The scale factor estimation unit 130 operates in the same manner as in the fifth embodiment.

The vehicle speed estimation unit 140 estimates the actual vehicle speed based on the scale factor corresponding to the wheel speed estimated by the scale factor estimation unit 130. Further, as shown in FIG. 11A and FIG. 11B, as the vehicle speed at time to, the actual vehicle speed is output by shifting the time at which the wheel speed is referenced by the time lag amount estimated by the time lag calculation unit 170.

The cause of time lag will be explained here. Even if the wheel speed and the GNSS speed are exactly the same without any error, a time lag may occur between them due to processing delays within the wheel speed sensor 50 or the GNSS receiver 60. Generally, the GNSS speed is provided with highly accurate time information inherent to GNSS. On the other hand, since the wheel speed sensor 50 and the acceleration sensor 70 do not have time information, time information is added in consideration of sensor delays for processing. Therefore, a slight time lag may occur with respect to the GNSS speed.

FIG. 11A and FIG. 11B show the relationship of speed error with respect to acceleration when there is a time lag between the wheel speed corrected by the scale factor corresponding to the speed and the GNSS speed. FIG. 11A shows the case where the wheel speed is delayed, and FIG. 11B shows the case where the wheel speed is advanced. As shown in FIG. 11A and FIG. 11B, when the magnitude of the time lag is ΔT, and ΔT is sufficiently small and the acceleration x can be regarded as constant, the speed error becomes ΔT·x. The sign of ΔT changes depending on whether the time lag is an advance or a delay, and the slope of the speed error is proportional to ΔT (see the solid lines in the right diagrams of FIG. 11A and FIG. 11B). Here, the solid lines in the right diagrams of FIG. 11A and FIG. 11B represent the “speed error with respect to acceleration” in the presence of a time lag. The dashed lines indicate the “speed error with respect to acceleration” when the wheel speed before or after ΔT is used. If the acceleration changes so much during ΔT that it cannot be regarded as constant, the speed error corresponds not to ΔT·x but to the amount obtained by integrating the acceleration over the time interval ΔT.

The calculation of the magnitude of the time lag ΔT is performed by the following procedure. First, the scale factor estimation unit 130 estimates the scale factor corresponding to the speed only when the acceleration is equal to or less than the threshold value, as in the fifth embodiment described above. Next, when the acceleration exceeds the threshold value, the time lag calculation unit 170 observes whether the speed error or the scale factor changes in the positive or negative direction, and applies the least squares method to determine the slope with respect to acceleration. This slope becomes the magnitude of the time lag ΔT. The sign of the slope corresponds to whether the time lag is an advance or a delay.

Here, if the error corresponding to the acceleration is directly reflected in the change of the scale factor to estimate the speed, the result is the same as in the third or fourth embodiment. On the other hand, in the sixth embodiment, the magnitude of the time lag ΔT is obtained and the time lag is corrected, thereby reducing the error dependent on acceleration as a result.

In FIG. 11A and FIG. 11B, the current reference time for the GNSS speed is indicated as t0, and the time for the wheel speed is offset by ΔT. In FIG. 11A, since the wheel speed is delayed, the wheel speed at ΔT after t0 should be referenced as the wheel speed at time to, in order to match the time of the GNSS speed at t0. In FIG. 11B, since the wheel speed is advanced, the wheel speed at ΔT before t0 should similarly be referenced as the wheel speed at time to. Alternatively, by integrating the acceleration over the time interval by which the reference time is shifted and adding the resulting speed variation to the original wheel speed, the same effect as shifting the reference time can be obtained.

In the present embodiment, by configuring the system in this way, it is possible to calculate the actual vehicle speed with higher accuracy regardless of the magnitude of the acceleration.

Regarding the correction of the time lag, the reference time for the wheel speed may be directly shifted, or the vehicle speed may be estimated by adding the speed variation amount obtained by integrating the acceleration over the time interval of the time lag, and the same effect can be obtained.

As described above, the vehicle speed estimation device 100 and the position calculation device 200 according to the embodiment have been illustrated and explained. The embodiment may also be in the form of a program for causing a computer to execute the functions of each unit provided in the vehicle speed estimation device 100 and the position calculation device 200. Furthermore, the embodiment may be in the form of a non-transitory storage medium readable by a computer, in which such programs are stored.

It should be noted that the present disclosure is not limited to the above-described embodiment, and various modifications other than those described above may be made without departing from the spirit thereof.

In addition, the processing flow of the program described in the above embodiment is merely an example. Therefore, in the above embodiment, unnecessary steps may be deleted, new steps may be added, or the order of processing may be changed, as long as such modifications do not depart from the gist of the invention.

Furthermore, in the above embodiment, the case in which the processing according to the embodiment is realized by a software configuration using a computer by executing a program has been described, but the invention is not limited thereto. The embodiment may also be realized, for example, by a hardware configuration or by a combination of a hardware configuration and a software configuration.

What is claimed is:

1. A vehicle speed estimation device comprising:
at least one processor configured to cause the vehicle speed estimation device to:
calculate a first vehicle speed of a vehicle based on a wheel speed sensor;
calculate a second vehicle speed of the vehicle based on a signal from a positioning satellite;
estimate a scale factor corresponding to the first vehicle speed, based on a ratio of the second vehicle speed to the first vehicle speed and a relationship with the first vehicle speed;
estimate an actual vehicle speed of the vehicle by multiplying the first vehicle speed by the scale factor;
calculate acceleration of the vehicle by an acceleration sensor; and
calculate a speed variation amount, which is a change in speed obtained by integrating the acceleration,
wherein
the at least one processor is further configured to:
estimate the scale factor corresponding to the first vehicle speed, based on the ratio of the second vehicle speed to the first vehicle speed and the relationship with the first vehicle speed, when the acceleration is equal to or less than a threshold value; and
estimate the actual vehicle speed based on the scale factor corresponding to the first vehicle speed when the acceleration is equal to or less than the threshold value, and estimates the actual vehicle speed by adding the speed variation amount based on the acceleration to the first vehicle speed when the acceleration exceeds the threshold value.

2. The vehicle speed estimation device according to claim 1, wherein
the at least one processor is configured to function as:
a first vehicle speed calculation unit that calculates the first vehicle speed of the vehicle based on the wheel speed sensor;
a second vehicle speed calculation unit that calculates the second vehicle speed of the vehicle based on the signal from the positioning satellite;
a scale factor estimation unit that estimates the scale factor corresponding to the first vehicle speed, based on the ratio of the second vehicle speed to the first vehicle speed and the relationship with the first vehicle speed;
a vehicle speed estimation unit that estimates the actual vehicle speed of the vehicle by multiplying the first vehicle speed by the scale factor;
an acceleration calculation unit that calculates the acceleration of the vehicle by the acceleration sensor; and
a speed variation calculation unit that calculates the speed variation amount, which is the change in speed obtained by integrating the acceleration,
wherein
the scale factor estimation unit estimates the scale factor corresponding to the first vehicle speed, based on the ratio of the second vehicle speed to the first vehicle speed and the relationship with the first vehicle speed, when the acceleration is equal to or less than a threshold value, and
the vehicle speed estimation unit estimates the actual vehicle speed based on the scale factor corresponding to the first vehicle speed when the acceleration is equal to or less than the threshold value, and estimates the actual vehicle speed by adding the speed variation amount based on the acceleration to the first vehicle speed when the acceleration exceeds the threshold value.

3. The vehicle speed estimation device according to claim 2, wherein the scale factor estimation unit divides a speed range of the vehicle into a plurality of ranges and estimates the scale factor for each speed range.

4. A vehicle speed estimation device comprising:
at least one processor configured to cause the vehicle speed estimation device to:
calculate a first vehicle speed of a vehicle based on a wheel speed sensor;
calculate a second vehicle speed of the vehicle based on a signal from a positioning satellite;
estimate a scale factor corresponding to the first vehicle speed, based on a ratio of the second vehicle speed to the first vehicle speed and a relationship with the first vehicle speed;
estimate an actual vehicle speed of the vehicle by multiplying the first vehicle speed by the scale factor;
calculate acceleration of the vehicle by an acceleration sensor; and
calculate a time lag amount between the first vehicle speed and the second vehicle speed, based on a difference between the first vehicle speed corrected by the estimated scale factor corresponding to the first vehicle speed and the second vehicle speed, with respect to the acceleration,
wherein
the at least one processor is further configured to
estimate the scale factor corresponding to the first vehicle speed, based on the ratio of the second vehicle speed to the first vehicle speed and the relationship with the first vehicle speed, when the acceleration is equal to or less than a threshold value, and
estimate the actual vehicle speed based on the scale factor corresponding to the first vehicle speed when the acceleration is equal to or less than the threshold value, and outputs the actual vehicle speed by shifting a time at which the first vehicle speed is referenced, by the time lag amount corresponding to the time lag when the acceleration exceeds the threshold value.

5. The vehicle speed estimation device according to claim 4, wherein
the at least one processor is configured to function as:
a first vehicle speed calculation unit that calculates the first vehicle speed of the vehicle based on the wheel speed sensor;
a second vehicle speed calculation unit that calculates the second vehicle speed of the vehicle based on the signal from the positioning satellite;
a scale factor estimation unit that estimates the scale factor corresponding to the first vehicle speed, based on the ratio of the second vehicle speed to the first vehicle speed and the relationship with the first vehicle speed;
a vehicle speed estimation unit that estimates the actual vehicle speed of the vehicle by multiplying the first vehicle speed by the scale factor;
an acceleration calculation unit that calculates the acceleration of the vehicle by the acceleration sensor; and
a time lag calculation unit that calculates the time lag amount between the first vehicle speed and the second vehicle speed, based on the difference between the first vehicle speed corrected by the scale factor estimated by the scale factor estimation unit corresponding to the first vehicle speed and the second vehicle speed, with respect to the acceleration,
wherein
the scale factor estimation unit estimates the scale factor corresponding to the first vehicle speed, based on the ratio of the second vehicle speed to the first vehicle speed and the relationship with the first vehicle speed, when the acceleration is equal to or less than the threshold value, and
the vehicle speed estimation unit estimates the actual vehicle speed based on the scale factor corresponding to the first vehicle speed when the acceleration is equal to or less than the threshold value, and outputs the actual vehicle speed by shifting the time at which the first vehicle speed is referenced, by the time lag amount corresponding to the time lag when the acceleration exceeds the threshold value.

6. The vehicle speed estimation device according to claim 5, wherein
the scale factor estimation unit divides a speed range of the vehicle into a plurality of ranges and estimates the scale factor for each speed range.

7. A position calculation device comprising:
a vehicle speed estimation device configured to estimate an actual vehicle speed of a vehicle; and
a position calculation device configured to calculate a position of the vehicle based on the actual vehicle speed estimated by the vehicle speed estimation device,
wherein
the vehicle speed estimation device comprises:
a first vehicle speed calculation unit configured to calculate a first vehicle speed of the vehicle based on a wheel speed sensor;
a second vehicle speed calculation unit configured to calculate a second vehicle speed of the vehicle based on a signal from a positioning satellite;
a scale factor estimation unit configured to estimate a scale factor corresponding to the first vehicle speed, based on a ratio of the second vehicle speed to the first vehicle speed and a relationship with the first vehicle speed;
a vehicle speed estimation unit configured to estimate the actual vehicle speed of the vehicle by multiplying the first vehicle speed by the scale factor;
an acceleration calculation unit configured to calculate acceleration of the vehicle by an acceleration sensor; and
a speed variation calculation unit configured to calculate a speed variation amount, which is a change in speed obtained by integrating the acceleration,
wherein
the scale factor estimation unit estimates the scale factor corresponding to the first vehicle speed, based on the ratio of the second vehicle speed to the first vehicle speed and the relationship with the first vehicle speed, when the acceleration is equal to or less than a threshold value, and
the vehicle speed estimation unit estimates the actual vehicle speed based on the scale factor corresponding to the first vehicle speed when the acceleration is equal to or less than the threshold value, and estimates the actual vehicle speed by adding the speed variation amount based on the acceleration to the first vehicle speed when the acceleration exceeds the threshold value.

8. A non-transitory computer readable storage medium storing a program for causing a computer to function as:
a first vehicle speed calculation unit configured to calculate a first vehicle speed of a vehicle based on a wheel speed sensor;
a second vehicle speed calculation unit configured to calculate a second vehicle speed of the vehicle based on signals from a positioning satellite;
a scale factor estimation unit configured to estimate a scale factor corresponding to the first vehicle speed, based on a ratio of the second vehicle speed to the first vehicle speed and a relationship with the first vehicle speed;
a vehicle speed estimation unit configured to estimate an actual vehicle speed of the vehicle by multiplying the first vehicle speed by the scale factor;
an acceleration calculation unit configured to calculate acceleration of the vehicle by an acceleration sensor; and
a speed variation calculation unit configured to calculate a speed variation amount, which is a change in speed obtained by integrating the acceleration,
wherein
the scale factor estimation unit estimates the scale factor corresponding to the first vehicle speed, based on the ratio of the second vehicle speed to the first vehicle speed and the relationship with the first vehicle speed, when the acceleration is equal to or less than a threshold value, and
the vehicle speed estimation unit estimates the actual vehicle speed based on the scale factor corresponding to the first vehicle speed when the acceleration is equal to or less than the threshold value, and estimates the actual vehicle speed by adding the speed variation amount based on the acceleration to the first vehicle speed when the acceleration exceeds the threshold value.
